(19) United States
(12) Patent Application Publication
(10) Pub. No.: US 2021/0354407 A1
(43) Pub. Date: Nov. 18, 2021

(54) SELF-SEALING COMPOSITIONS

(71) Applicant: COMPAGNIE GENERALE DES ETABLISSEMENTS MICHELIN, Clermont-Ferrand (FR)

(72) Inventors: CHRISTOPHE CHOUVEL, Clermont-Ferrand (FR); DAVID GONZALEZ, Clermont-Ferrand (FR); SALVATORE PAGANO, Clermont-Ferrand (FR)

(21) Appl. No.: 17/282,239

(22) PCT Filed: Oct. 1, 2019
(86) PCT No.: PCT/FR2019/052316

§ 371 Date: Apr. 1, 2021

(30) Foreign Application Priority Data
Oct. 3, 2018 (FR) 1859154

(51) Int. Cl. B29C 73/16; C08L 23/22; B60C 19/12; C08L 53/02

(52) U.S. Cl. CPC B29C 73/163; C08L 23/22; C08L 91/00; C08L 53/02; B60C 19/122

(57) ABSTRACT

A self-sealing composition is based on at least: one thermoplastic styrene elastomer; one polyolefin having a number-average molar mass Mn ranging from more than 550 000 to 5 000 000 g/mol; and at least 140 phr of an extender oil.

The present invention relates to a self-sealing composition and to its use as puncture-resistant layer in a pneumatic object, in particular in a pneumatic tyre.

Generally, a pneumatic object, such as a pneumatic tyre, comprises an airtight internal layer delimiting its internal volume. This layer generally comprises a composition based on butyl rubber which is known to be impermeable to inflation gases, such as air.

During its use, the pneumatic object may experience a perforation subsequent to the penetration of a perforating object, such as, for example, a nail or a screw. This perforation results in an escape of the inflation gases. The loss in pressure as a result of this perforation renders the pneumatic object unusable. In the case of a pneumatic tyre, a perforation results in the the tyre becoming flat, the halting of the vehicle and the replacement of the wheel concerned by a spare wheel.

In order to solve this problem of puncturing, one of the many existing solutions consists in adding, to the internal wall of the pneumatic object, an additional layer of a relatively flexible composition which can easily yield. Thus, during a perforation, the composition of the additional layer, due to its flexibility and its ability to easily yield, penetrates into the perforation, recloses this perforation and prevents the loss in pressure resulting from this perforation. Such a composition is said to be self-sealing.

In order to be usable, such a self-sealing composition has to satisfy numerous conditions of physical and chemical natures. It must in particular be effective over a very wide range of working temperatures, and be so throughout the lifetime of the pneumatic objects. It must be capable of blocking perforations or holes whether the perforating object responsible remains in place or is expelled.

Such a composition is, for example, described in the document WO2008/080557A1. This composition comprises a styrene thermoplastic elastomer as predominant elastomer and an extender oil at a content of between 200 and 700 phr.

With the aim of improving the self-sealing properties of these compositions, the Applicant Company has discovered that the addition of a polyolefin of specific mass to a self-sealing composition comprising a thermoplastic styrene elastomer and an extender oil makes it possible to obtain a novel composition exhibiting improved self-sealing properties, whatever the shape of the perforating object, compared with the self-sealing compositions of the prior art.

Thus, a first subject-matter of the present invention relates to a self-sealing composition based on at least:
one thermoplastic styrene elastomer;
one polyolefin having a number-average molar mass Mn ranging from more than 550 000 to 5 000 000 g/mol; and
at least 140 phr of an extender oil.

The self-sealing compositions according to the invention exhibit in particular the advantage of having improved self-sealing properties, especially when the perforating object is a slender object having walls comprising a thread (such as a screw), while retaining its self-sealing properties in the presence of a slender perforating object having smooth walls (such as a nail).

This self-sealing composition in accordance with the invention can be intended to be incorporated in a pneumatic object, such as a pneumatic tyre.

Consequently, another subject-matter of the present invention is the use of the self-sealing composition as defined above as puncture-resistant layer, in particular for a pneumatic object, especially for a pneumatic tyre.

Another subject-matter of the present invention relates to a laminate which is airtight to inflation gases and puncture-resistant, in particular for a pneumatic object, such as a pneumatic tyre, comprising at least:
one puncture-resistant layer consisting of a self-sealing composition as defined above; and
one layer airtight to inflation gases.

Another subject-matter of the invention relates to the use of the laminate as defined above as internal wall of a pneumatic object, such as a pneumatic tyre.

Another subject-matter of the present invention is a pneumatic object comprising at least one self-sealing composition as defined above or at least one laminate which is airtight to inflation gases and puncture-resistant, as defined above. Preferably, the pneumatic object is a pneumatic tyre.

The self-sealing compositions in accordance with the invention additionally exhibit, in particular, the advantage of being able to be applied directly to the internal wall of a cured pneumatic tyre without it being necessary to remove the film of mould-release agents located at the surface of this internal wall.

This is because the internal wall of a pneumatic tyre often comprises a layer airtight to inflation gases which exhibits a strong adhesiveness in the raw state. In order to prevent the raw pneumatic tyre from sticking to the curing bladder of the vulcanization press and from damaging this press, it is normal to deposit mould-release agents, in the form of a film, on the surface of this internal wall. This film of mould-release agents acts as a non-stick protective layer. When an object has to be adhesively bonded to the internal wall of the cured (or vulcanized) pneumatic tyre, it is thus necessary to remove the film of mould-release agents by scraping or else using a solvent, in order to adhesively bond the object.

Surprisingly, the self-sealing compositions in accordance with the invention can be deposited directly on the internal wall of the cured pneumatic tyre, without requiring a removal of the film of mould-release agents. This results in a simplification of the process for depositing the self-sealing composition, a saving in time and a gain in safety for the manufacturers.

### 1 DESCRIPTION OF THE FIGURES

FIG. 1 diagrammatically represents (without observing a specific scale) a radial section of a pneumatic tyre incorporating a laminate in accordance with the invention.

FIGS. 2 to 5 illustrate different aspects of the method for testing the resistance to a loss in pressure of a tyre in the case of a tyre comprising a self-sealing composition on its internal wall.

FIG. 2 illustrates the case of a perforation with a zero rate of leakage.

FIGS. 3(a) and 3(b) illustrate the cases of a perforation with a very low rate of leakage.

FIG. 4 illustrates the case of a perforation with a low rate of leakage.

FIGS. 5(a) and 5(b) illustrate the cases of a perforation with a rapid rate of leakage.

### 2 METHODS USED

### 2.1 Method for Measuring the Number-Average Molar Mass, the Weight-Average Molar Mass and the Polydispersity Index

The number-average molar mass (Mn), the weight-average molar mass (Mw) and the polydispersity index (PI) of the constituents which can be used in the compositions of the layers of the laminate in accordance with the invention (thermoplastic styrene elastomer, extender oil and polyolefin) are determined in a known way, by triple detection size exclusion chromatography (SEC). This technique exhibits the advantage of measuring average molar masses directly, without calibration.

In a first step, the refractive index increment do/dc of the sample (i.e. of the constituent of the composition for which it is desired to determine the Mn and if appropriate the Mw and the PI) is determined. For this, the sample is dissolved beforehand in tetrahydrofuran at different precisely known concentrations (0.5 g/l, 0.7 g/l, 0.8 g/1, 1 g/l and 1.5 g/l) and then each solution is filtered through a filter with a porosity of 0.45 μm. Each solution is subsequently directly injected, using a syringe driver, into a Wyatt differential refractometer of Optilab T-Rex trade name of wavelength 658 nm and thermostatically controlled at 35° C. The refractive index is measured by the refractometer for each concentration. The Astra software from Wyatt produces a straight line of the signal of the detector as a function of the concentration of the sample. The Astra software automatically determines the director coefficient of the straight line corresponding to the refractive index increment of the sample in tetrahydrofuran at 35° C. (dn/dc) and to the wavelength of 658 nm.

In order to determine the average molar masses, use is made of the 1 g/l solution of the sample prepared and filtered previously, which is injected into the chromatographic system. The apparatus used is a Waters Alliance chromatographic line. The elution solvent is tetrahydrofuran protected from oxidation with 250 ppm of BHT (2,6-di(tert-butyl)-4-hydroxytoluene), the flow rate is 1 ml·min⁻¹, the temperature of the system is 35° C. and the analytical time is 60 min. The columns used are a set of three Agilent columns of PL Gel Mixed B LS trade name. The volume of the solution of the sample injected is 100 μl. The detection system is composed of a Wyatt differential viscometer of Viscostar II trade name, of a Wyatt differential refractometer of Optilab T-Rex trade name of wavelength 658 nm and of a Wyatt multi-angle static light scattering detector of wavelength 658 nm and of Dawn Heleos 8+ trade name.

The value of the refractive index increment do/dc of the 1 g/l solution of the sample obtained above is integrated for the calculation of Mn, Mw and PI. The software for making use of the chromatographic data is the Astra system from Wyatt.

### 2.2 Method for Measuring the Thicknesses of the Layers

The thicknesses of the layers are measured according to any normal method known to a person skilled in the art.

For example, a sample (2 cm*2 cm) of the multilayer laminate is available, which sample is positioned on a hemispherical magnetic observation support of a Leica M205C stereomicroscope. The laminate is observed layer by layer in order to measure the thickness of each of the layers of the laminate.

### 2.3 Method for Measuring the Glass Transition Temperature Tg of the Polymers

The glass transition temperature Tg (hereinafter known as Tg) is measured in a known way by DSC (Differential Scanning calorimetry) according to Standard ASTM D3418 of 1999.

### 3 DETAILED DESCRIPTION OF THE INVENTION

The invention and its advantages will be easily understood in the light of the description, of the figures and of the exemplary embodiments.

In the present description, unless expressly indicated otherwise, all the percentages (%) shown are percentages by weight.

Furthermore, any interval of values denoted by the expression “between a and b” represents the range of values extending from more than “a” to less than “b” (that is to say, limits a and b excluded), whereas any interval of values denoted by the expression “from a to b” means the range of values extending from “a” up to “b” (that is to say, including the strict limits a and b).

In the present patent application, “part per hundred of elastomer” or “phr” is understood to mean the part by weight of a constituent per hundred parts by weight of elastomers, all the elastomers being intermingled, thermoplastic or non-thermoplastic, diene or olefinic. In the present document, the polyolefins described hereinafter in point 3.1.2, the molar mass of which is greater than 550 000 g/mol, are thus taken into account in the total elastomer weight.

In the context of the invention, the carbon-based products mentioned in the description can be of fossil or biosourced origin. In the latter case, they can partially or completely result from biomass or be obtained from renewable starting materials resulting from biomass. Polymers, plasticizers, fillers, and the like, are concerned in particular.

### 3.1 Self-Sealing Composition

A first subject-matter of the present invention relates to a self-sealing composition based on at least:
one thermoplastic styrene elastomer;
one polyolefin having a number-average molar mass Mn ranging from more than 550 000 to 5 000 000 g/mol, and
at least 140 phr of an extender oil.

The self-sealing composition of the invention described above is a solid (at 23° C.) and elastic compound, which is characterized in particular, by virtue of its specific formulation, by a very high flexibility and deformability.

The term “composition based on” should be understood as meaning, within the meaning of the present invention, a composition comprising the mixture and/or the reaction product of the various constituents used, some of these base constituents being capable of reacting, or intended to react, with one another, at least in part, during the various phases of manufacture of the composition, in particular during its extrusion or during the mixing phase.

### 3.1.1 Thermoplastic Styrene Elastomer

As mentioned above, the compositions in accordance with the invention comprise at least one thermoplastic styrene elastomer.

The thermoplastic styrene elastomers (abbreviated to TPSs) come within, in a known way, the family of the thermoplastic elastomers (abbreviated to TPEs). Intermediate in structure between elastomers and thermoplastic polymers, they consist of rigid thermoplastic styrene blocks connected by flexible elastomer blocks.

The thermoplastic styrene elastomer used for the implementation of the invention is a block copolymer, the chemical nature of the thermoplastic blocks and elastomer blocks of which can vary.

Structure of the Thermoplastic Styrene Elastomer

The number-average molar mass (denoted Mn) of the thermoplastic styrene elastomer is preferably less than or equal to 500 000 g/mol. More preferably, it is within a range extending from 30 000 to 500 000 g/mol, preferably from 40 000 to 400 000 g/mol, more preferably still from 50 000 g/mol to 300 000 g/mol. Below the minima indicated, there is a risk of the cohesion between the elastomer chains of the thermoplastic styrene elastomer being affected, in particular due to its possible dilution (in the presence of an extender oil); furthermore, there is a risk of an increase in the working temperature affecting the mechanical properties, in particular the properties at break, with the consequence of a reduced “hot” performance. Furthermore, an excessively high Mn mass can be detrimental to the processability. Thus, it has been found that a value within a preferred range from 50 000 to 300 000 g/mol was particularly well suited, in particular to use of the thermoplastic styrene elastomer A in a self-sealing composition according to the invention.

The number-average molar mass (Mn), the weight-average molar mass (Mw) and the polydispersity index (PI) of the thermoplastic styrene elastomer is determined in a known way by triple detection size exclusion chromatography (SEC), as described above.

The value of the polydispersity index PI (reminder: PI=Mw/Mn, with Mw the weight-average molar mass and Mn the number-average molar mass) of the thermoplastic styrene elastomer is preferably less than 3, more preferably less than 2 and more preferably still less than 1.5.

In a known way, TPSs exhibit two glass transition temperature Tg peaks, the lowest temperature being relative to the elastomer part of the TPS and the highest temperature being relative to the thermoplastic styrene part of the TPS. Thus, the flexible blocks of the TPSs are defined by a Tg which is less than ambient temperature (25° C.), while the rigid blocks have a Tg of greater than or equal to 80° C.

In the present patent application, when reference is made to the glass transition temperature of the thermoplastic styrene elastomer, it concerns the Tg relative to the elastomer block. The thermoplastic styrene elastomer preferably exhibits a Tg of less than 25° C., more preferably of less than or equal to 10° C. A Tg value greater than these minima can reduce the performance qualities of the self-sealing composition when used at very low temperature; for such a use, the Tg of the thermoplastic styrene elastomer is more preferably still less than or equal to −10° C. Preferably also, the Tg of the thermoplastic styrene elastomer is greater than or equal to −100° C.

In order to be both elastomeric and thermoplastic in nature, the thermoplastic styrene elastomer has to be provided with blocks which are sufficiently incompatible (that is to say, different as a result of their respective weights/masses, their respective polarities or their respective Tg values) to retain their own properties of elastomer block or thermoplastic block.

The TPSs can be copolymers with a small number of blocks (less than 5, typically 2 or 3), in which case these blocks preferably have high weights/masses, of greater than 15 000 g/mol. These TPSs can, for example, be diblock copolymers, comprising a thermoplastic styrene block and an elastomer block. These are often also triblock elastomers with two rigid segments connected by a flexible segment. The rigid and flexible segments can be positioned linearly, in a star or branched configuration. Typically, each of these segments or blocks often contains a minimum of more than 5, generally of more than 10, base units (for example, styrene units and butadiene units for a styrene/butadiene/styrene block copolymer).

The TPSs can also comprise a large number of smaller blocks (more than 30, typically from 50 to 500), in which case these blocks preferably have relatively low weights/masses, for example from 500 to 5000 g/mol. These TPSs will subsequently be referred to as multiblock TPSs and are an elastomer block/thermoplastic styrene block series.

According to a first alternative form, the thermoplastic styrene elastomer is provided in a linear form. For example, the thermoplastic styrene elastomer is a diblock copolymer: thermoplastic block/elastomer block. The thermoplastic styrene elastomer can also be a triblock copolymer: thermoplastic block/elastomer block/thermoplastic block, that is to say a central elastomer block and two terminal thermoplastic blocks, at each of the two ends of the elastomer block. Equally, the multiblock thermoplastic styrene elastomer can be a linear series of elastomer blocks/thermoplastic blocks.

According to another alternative form of the invention, the thermoplastic styrene elastomer of use for the requirements of the invention is provided in a star-branched form comprising at least three branches. For example, the thermoplastic styrene elastomer can then be composed of a star-branched elastomer block comprising at least three branches and of a thermoplastic styrene block located at the end of each of the branches of the elastomer block. The number of branches of the central elastomer can vary, for example, from 3 to 12 and preferably from 3 to 6.

According to another alternative form of the invention, the thermoplastic styrene elastomer is provided in a branched or dendrimer form. The thermoplastic styrene elastomer can then be composed of a branched or dendrimer elastomer block and of a thermoplastic styrene block located at the end of the branches of the dendrimer elastomer block.

Preferably, the thermoplastic styrene elastomer is selected from the group consisting of triblock thermoplastic styrene elastomers and the mixtures of these elastomers.

Nature of the Elastomer Blocks of the Thermoplastic Styrene Elastomer

The elastomer blocks of the thermoplastic styrene elastomer for the requirements of the invention can be any elastomer known to a person skilled in the art. They preferably have a Tg of less than 25° C., preferentially of less than 10° C., more preferentially of less than 0° C. and very preferentially of less than −10° C. Also preferentially, the elastomer block Tg of the thermoplastic styrene elastomer is greater than −100° C.

For the elastomer blocks comprising a carbon-based chain, if the elastomer block of the thermoplastic styrene elastomer comprises ethylenic unsaturations (that is to say, carbon-carbon double bonds), the term used will then be that of an unsaturated or diene elastomer (or unsaturated thermoplastic styrene elastomer) block. If the elastomer block of the thermoplastic styrene elastomer does not comprise an ethylenic unsaturation, the term used will then be that of a saturated elastomer (or saturated thermoplastic styrene elastomer) block.

In the case of the unsaturated elastomer blocks, this elastomer block of the thermoplastic styrene elastomer is preferably predominantly composed of a diene elastomer part. Predominantly is understood to mean a highest content by weight of diene monomer, with respect to the total weight of the elastomer block, and preferably a content by weight of more than 50%, more preferably of more than 75% and more preferably still of more than 85%. Alternatively, the unsaturation of the unsaturated elastomer block can originate from a monomer comprising a double bond and an unsaturation of cyclic type; this is the case, for example, in polynorbornene.

Preferably, conjugated C₄-C₁₄ dienes can be polymerized or copolymerized in order to form a diene elastomer block. Preferably, these conjugated dienes are chosen from isoprene, butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadiene, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1,3-cyclopentadiene, methylcyclopentadiene, 2-methyl-1,6-heptadiene, 1,3-cyclohexadiene, 1-vinyl-1,3-cyclohexadiene or their mixture. More preferably, the conjugated diene is isoprene or butadiene or a mixture comprising isoprene and/or butadiene.

According to an alternative form, the diene monomers polymerized in order to form the elastomer part of the thermoplastic styrene elastomer A can be randomly copolymerized with at least one other monomer, so as to form an unsaturated elastomer block. According to this alternative form, the molar fraction of polymerized monomer, other than a diene monomer, with respect to the total number of units of the elastomer block, has to be such that this block retains its elastomer properties. Preferably, the molar fraction of this other comonomer can range from 0% to 50%, more preferably from 0% to 45% and more preferably still from 0% to 40%.

By way of illustration, this other monomer capable of copolymerizing with the diene monomer can be chosen from ethylenic monomers, such as ethylene, propylene or butylene, monomers of vinylaromatic type having from 8 to 20 carbon atoms as defined below, or also a monomer such as vinyl acetate may be involved.

When the comonomer is of vinylaromatic type, it preferably represents a molar fraction of units, with regard to the total number of units of the thermoplastic block, from 0% to 50%, preferably ranging from 0% to 45% and more preferably still ranging from 0% to 40%. The styrene monomers mentioned below, namely styrene, methylstyrenes, para(tert-butyl)styrene, chlorostyrenes, bromostyrenes, fluorostyrenes or also para-hydroxystyrene, are suitable in particular as vinylaromatic compounds. Preferably, the comonomer of vinylaromatic type is styrene.

Preferably, the thermoplastic styrene elastomer which can be used in the self-sealing compositions of the invention is selected from the group consisting of saturated thermoplastic styrene elastomers and the mixtures of these elastomers.

More preferably still, the thermoplastic styrene elastomer which can be used in the compositions of the invention is selected from the group consisting of saturated triblock thermoplastic styrene elastomers and the mixtures of these elastomers.

A saturated elastomer block is composed of a polymer sequence obtained by the polymerization of at least one ethylenic monomer, that is to say, a monomer comprising a carbon-carbon double bond. Mention may be made, among the blocks resulting from these ethylenic monomers, of polyalkylene blocks, such as ethylene/propylene or ethylene/butylene random copolymers. These saturated elastomer blocks can also be obtained by hydrogenation of unsaturated elastomer blocks. They can also be aliphatic blocks resulting from the family of the polyethers, polyesters or polycarbonates.

In the case of the saturated elastomer blocks, this elastomer block of the thermoplastic styrene elastomer is preferably predominantly composed of ethylenic units. Predominantly is understood to mean a highest content by weight of ethylenic monomer, with respect to the total weight of the elastomer block, and preferably a content by weight of more than 50%, more preferably of more than 75%, more preferably of more than 85%, more preferably of more than 90% and more preferably still of more than 95%.

By way of illustration, the other monomers capable of copolymerizing with the ethyleneic monomer can be chosen from diene monomers (as defined below), more particularly the conjugated diene monomers having from 4 to 14 carbon atoms as defined below (for example butadiene), monomers of vinylaromatic type having from 8 to 20 carbon atoms as defined above, or also a monomer such as vinyl acetate may be involved.

When the comonomer is of vinylaromatic type, the content by weight of this comonomer, with respect to the total weight of the elastomer block, is within a range extending from 0% to 50%, preferably extending from 0% to 45% and more preferably still extending from 0% to 40%. The styrene monomers mentioned below, in particular styrene, methylstyrenes, para(tert-butyl)styrene, chlorostyrenes, bromostyrenes, fluorostyrenes or also para-hydroxystyrene, are suitable in particular as vinylaromatic compounds. Preferably, the comonomer of vinylaromatic type is styrene.

When the comonomer is of diene type, the content by weight of this comonomer, with respect to the total weight of the elastomer block, is within a range extending from 0% to 15%, preferably extending from 0% to 10% and more preferably still extending from 0% to 5%. Conjugated C₄-C₁₄ dienes are suitable in particular as diene comonomer. They are, in this case, random copolymers. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is isoprene or a mixture comprising isoprene.

Preferably, the elastomer blocks of the thermoplastic styrene elastomer A exhibit, in total, a number-average molar mass (Mn) ranging from 25 000 to 350 000 g/mol, preferably from 35 000 to 250 000 g/mol, so as to confer, on the thermoplastic styrene elastomer, good elastomeric properties and a mechanical strength which is sufficient and compatible with the use in a self-sealing composition.

The elastomer block can also be a block comprising several types of ethylenic, diene or styrene monomers as defined above.

The elastomer block can also consist of several elastomer blocks as defined above.

Nature of the Thermoplastic Styrene Blocks of the Thermoplastic Styrene Elastomer

The proportion of the thermoplastic styrene blocks, with respect to the thermoplastic styrene elastomer, as defined for the use in self-sealing compositions, is determined in particular by the thermoplasticity properties which the said copolymer has to exhibit. The thermoplastic styrene blocks are preferably present in proportions sufficient to retain the thermoplastic nature of the elastomer which can be used in the self-sealing compositions of the invention. The minimum content of thermoplastic styrene blocks in the thermoplastic styrene elastomer can vary as a function of the conditions of use of the copolymer. Moreover, the ability of the thermoplastic styrene elastomer to deform during the preparation of the self-sealing composition can also contribute to determining the proportion of the thermoplastic styrene blocks.

The thermoplastic styrene blocks are obtained from styrene monomers.

Styrene monomer should be understood, in the present description, as meaning any monomer comprising styrene, both unsubstituted and substituted; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or also para-hydroxystyrene.

Preferably, the content by weight of styrene monomers (preferably unsubstituted styrene monomers), in the thermoplastic styrene elastomer A, is between 5% and 50%. Below the minimum indicated, there is a risk of the thermoplastic nature of the elastomer being substantially reduced while, above the recommended maximum, the elasticity of the self-sealing composition can be affected. For these reasons, the content by weight of styrene monomers (preferably unsubstituted styrene monomers), in the thermoplastic styrene elastomer, is more preferably between 10% and 40%.

Preferably, the thermoplastic blocks of the thermoplastic styrene elastomer A exhibit, in total, a number-average molar mass (Mn) ranging from 5000 to 150 000 g/mol, so as to confer, on the thermoplastic styrene elastomer, good elastomeric properties and a mechanical strength which is sufficient and compatible with the use in a self-sealing composition.

The thermoplastic block can also consist of several thermoplastic blocks as defined above.

Examples of Thermoplastic Styrene Elastomers

Thermoplastic styrene elastomers are well known to a person skilled in the art and are commercially available.

Preferably, the thermoplastic styrene elastomer which can be used in the self-sealing compositions in accordance with the invention is a copolymer, the elastomer part of which is saturated, comprising styrene blocks and alkylene blocks. The alkylene blocks are preferably of ethylene, propylene or butylene.

For example, this saturated thermoplastic styrene elastomer is selected from the group consisting of styrene/ethylene/butylene (SEB) copolymers, styrene/ethylene/propylene (SEP) copolymers, styrene/ethylene/ethylene/propylene (SEEP) copolymers, styrene/ethylene/butylene/styrene (SEBS) copolymers, styrene/ethylene/propylene/styrene (SEPS) copolymers, styrene/ethylene/ethylene/propylene/styrene (SEEPS) copolymers and the mixtures of these copolymers.

More preferably still, the thermoplastic styrene elastomer which can be used in the self-sealing compositions in accordance with the invention is a copolymer, the elastomer part of which is saturated, comprising three blocks: two styrene blocks and one alkylene block. The alkylene blocks are preferably of ethylene, propylene or butylene.

Preferably, this saturated triblock thermoplastic styrene elastomer is selected from the group consisting of styrene/ethylene/butylene/styrene (SEBS) copolymers, styrene/ethylene/propylene/styrene (SEPS) copolymers and the mixtures of these copolymers.

Mention may be made, as examples of commercially available thermoplastic styrene elastomers, of the elastomers of SEPS, SEEPS or SEBS type sold by Kraton under the Kraton G name (e.g. G1650, G1651, G1654 and G1730 products) or Kuraray under the Septon name (e.g. Septon 2007, Septon 4033 or Septon 8004).

### 3.1.2 Polyolefin

As described above, the self-sealing compositions in accordance with the invention comprise at least one polyolefin having a number-average molar mass Mn ranging from more than 550 000 g/mol to 5 000 000 g/mol.

The number-average molar mass (Mn), the weight-average molar mass (Mw) and the polydispersity index (PI) of the polyolefin which can be used in the self-sealing compositions in accordance with the invention are determined in a known way by triple detection size exclusion chromatography (SEC), as described above.

The term “polyolefin” is understood to mean, within the meaning of the present patent application, an essentially saturated aliphatic polymer obtained by polymerization of at least one olefinic monomer, that is to say having a content by weight of units of olefinic origin of greater than or equal to 85%. An olefinic monomer comprises one (and just one) carbon-carbon double bond.

Preferably, the polyolefin comprises units resulting from olefinic monomers having from 4 to 8 carbon atoms.

The content by weight of units resulting from olefinic monomers having from 4 to 8 carbon atoms is greater than or equal to 85%, preferably greater than or equal to 90% and more preferably still greater than or equal to 95% by weight, with respect to the total weight of the polyolefin.

By way of illustration, the other monomers capable of copolymerizing with the olefinic monomer having from 4 to 8 carbon atoms can be chosen from diene monomers (as defined below), more particularly conjugated diene monomers having from 4 to 14 carbon atoms as defined below (for example butadiene). The content by weight of this comonomer, with respect to the total weight of the polyolefin, is within a range extending from 0% to 15%, preferably ranging from 0% to 10% and more preferably still ranging from 0% to 5%.

C₄-C₁₄ conjugated dienes are suitable in particular as diene comonomer. In this case, random copolymers are concerned. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is isoprene or a mixture comprising isoprene.

Preferably, the polyolefin is composed of units resulting from one or more olefinic monomers having from 4 to 8 carbon atoms.

Preferably, the olefinic monomers having from 4 to 8 carbon atoms are selected from the group consisting of but-1-ene, but-2-ene (cis and trans isomers of but-2-ene), 2-methylpropene, pent-1-ene, pent-2-ene, 2-methyl-1-butene, 2-methyl-2-butene, 3-methyl-1-butene, hex-1-ene, 4-methyl-1-pentene, 3-methyl-1-pentene, hept-1-ene and oct-1-ene, and the mixtures of these monomers.

Preferably, the polyolefin comprises units resulting from olefinic monomers having 4 carbon atoms selected from the group consisting of but-1-ene, but-2-ene (cis and trans isomers of but-2-ene), 2-methylpropene and the mixtures of these monomers.

Preferably, the polyolefin consists of units resulting from olefinic monomers having 4 carbon atoms selected from the group consisting of but-1-ene, but-2-ene (cis and trans isomers of but-2-ene), 2-methylpropene and the mixtures of these monomers.

Preferably, the polyolefin consists of units resulting from 2-methylpropene monomer. In other words, the polyolefin is a polyisobutylene (PIB).

Preferably, the polyolefin has a number-average molar mass Mn ranging from 600 000 to 5 000 000 g/mol, preferably ranging from 700 000 to 4 000 000 g/mol. More preferably, the polyolefin has a number-average molar mass ranging from 800 000 to 3 000 000 g/mol.

Preferably, the polyolefin has a polydispersity index PI within a range extending from 1.1 to 6, preferably extending from 1.3 to 5.

The polyolefins which can be used in the present invention can be obtained, for example, by any process known to a person skilled in the art, for example suspension polymerization or gas-phase polymerization with catalysts of Ziegler-Natta or metallocene type.

When the polyolefin is a polyisobutylene (PIB), it can also be obtained by polymerization from isobutylene in the presence of a catalyst of Lewis acid type, such as aluminium chloride AlCl₃ or boron trifluoride BF₃.

These polyolefins are commercially available from suppliers such as BASF, for example under the reference Oppanol B50 or Oppanol N50.

The self-sealing compositions in accordance with the present invention, as a result of the presence of at least one polyolefin as defined above surprisingly exhibit very good self-sealing properties for a perforation made with a slender object having walls comprising a thread, while also exhibiting excellent self-sealing properties for a perforation made with a slender object having smooth walls.

### 3.1.3 Diene Elastomer

The self-sealing compositions according to the invention as described above make it possible, by themselves alone, to respond to the technical problem posed; in particular, they make it possible to have excellent self-sealing properties, especially when a pneumatic object is perforated with a slender perforating object having walls comprising a thread.

However, the self-sealing composition in accordance with the invention can optionally comprise at least one diene elastomer.

“Diene” elastomer (or without distinction rubber), whether natural or synthetic, should be understood, in a known way, as meaning an elastomer constituted, at least in part (i.e., a homopolymer or a copolymer), of diene monomer units (monomers bearing two conjugated or non-conjugated carbon-carbon double bonds). These diene elastomers can be classified into two categories: “essentially unsaturated” or “essentially saturated”. “Essentially unsaturated” is generally understood to mean a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can be described in particular as “essentially saturated” diene elastomers (low or very low content, always less than 15%, of units of diene origin). Given these definitions, diene elastomer, whatever the above category, capable of being used in the compositions in accordance with the invention is understood more particularly to mean:
(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—any copolymer obtained by copolymerization of one or more conjugated or non-conjugated dienes with ethylene, an α-monoolefin or their mixture, such as, for example, the elastomers obtained from ethylene and propylene with a non-conjugated diene monomer, for example having from 6 to 12 carbon atoms.

Preferably, the diene elastomer is selected from the group consisting of polybutadienes (abbreviated to BRs), synthetic polyisoprenes (abbreviated to IRs), natural rubber (abbreviated to NR), butadiene copolymers, isoprene copolymers and the mixtures of these elastomers.

### 3.1.4 Content of Thermoplastic Styrene Elastomer, of Polyolefin and Optionally of Other Elastomers

A person skilled in the art will know, in the light of the description and exemplary embodiments which follow, how to adjust the amount of thermoplastic styrene elastomer and the amount of polyolefin in the self-sealing composition as a function of the specific conditions of use of this composition in a pneumatic object, in particular as a function of the laminate in which it is intended to be used.

Preferably, the content of thermoplastic styrene elastomer A present in the self-sealing compositions in accordance with the invention is greater than or equal to 10 phr, is preferably within a range extending from 10 to 90 phr, more preferably from 20 to 80 phr, more preferably still from 25 to 75 phr.

Preferably, the content of polyolefin in the self-sealing compositions in accordance with the invention is greater than or equal to 10 phr, is preferably within a range extending from 10 to 90 phr, more preferably from 20 to 80 phr, more preferably still from 25 to 75 phr.

Preferably, the content of diene elastomer is within a range extending from 0 to 20 phr, more preferably from 0 to 15 phr and more preferably still from 0 to 10 phr.

Preferably, the self-sealing composition of the invention does not contain diene elastomer.

Preferably, the ratio as phr of the content of thermoplastic styrene elastomer to the content of polyolefin is strictly less than 1.

### 3.1.5 Extender Oil

The third essential constituent of the self-sealing composition in accordance with the invention is an extender oil (or plasticizing oil), used at a high content, of at least 140 phr.

Use may be made, in the present invention, of any extender oil, preferably having a weakly polar nature, capable of extending or plasticizing thermoplastic styrene elastomers.

At ambient temperature (23° C.), these oils, which are more or less viscous, are liquids (that is to say, as a reminder, substances which have the ability to eventually assume the shape of their container), in contrast in particular to resins, especially tackifying resins, which are by nature solids.

Preferably, the extender oil is selected from the group consisting of polyolefinic oils (that is to say, oils resulting from the polymerization of monoolefinic or diolefinic olefins), paraffinic oils, naphthenic oils (of low or high viscosity), aromatic oils, mineral oils and the mixtures of these oils.

More preferably, the extender oil is selected from the group consisting of polyolefinic oils, paraffinic oils and the mixtures of these oils.

More preferably still, the extender oil is a polyolefinic oil or a mixture of polyolefinic oils. This oil has demonstrated the best compromise in properties, in comparison with the other oils tested, in particular in comparison with a conventional oil of the paraffinic type.

More preferably still, the extender oil is a polyolefinic oil selected from the group consisting of polybutene oils and the mixtures of these oils.

More preferably still, the extender oil is selected from the group consisting of polyisobutylene oils and the mixtures of these oils.

By way of examples, polyisobutylene oils are sold in particular by Univar under the name Dynapak Poly (e.g., Dynapak Poly 190), by BASF under the name Glissopal (e.g., Glissopal 1000) or by Ineos under the names H100, H300, H1200, H1500 or H1900; paraffinic oils are sold, for example, by ExxonMobil under the names Primol 352, Primol 382 or Primol 542 or under the names Flexon 815 or Flexon 715.

Preferably, the number-average molar mass (Mn) of the extender oil is less than or equal to 5000 g/mol, and preferably within a range extending from 300 to 5000 g/mol, more preferably still between 350 and 3000 g/mol. For weights/masses Mn of less than 300 g/mol, the oil might migrate to the outside of the self-sealing composition, while excessively high weights/masses might result in an excessive stiffening of the self-sealing composition.

The number-average molar mass (Mn), the weight-average molar mass (Mw) and the polydispersity index (PI) of the extender oil which can be used in the self-sealing compositions in accordance with the invention is determined in a known way by triple detection size exclusion chromatography (SEC), as described above.

Preferably, the content of extender oil is within a range extending from 145 to 500 phr, more preferably from 145 to 400 phr, more preferably still from 145 to 350 phr, preferably from more than 150 to 350 phr and very preferably from 160 to 350 phr. Below the minimum indicated, there is a risk of the self-sealing composition exhibiting a stiffness which is too high for some applications, whereas, above the recommended maximum, a risk arises of insufficient cohesion of the self-sealing composition. For this reason, the content of extender oil is more preferably between 145 and 500 phr, in particular for use of the self-sealing composition in a pneumatic tyre.

A person skilled in the art will know, in the light of the description and exemplary embodiments which follow, how to adjust the amount of extender oil as a function of the specific working conditions of the self-sealing composition, in particular as a function of the pneumatic object in which it is intended to be used.

### 3.1.6 Other Additives

The self-sealing compositions according to the invention as described above make it possible, by themselves alone, to respond to the technical problem posed; in particular, they make it possible to have excellent self-sealing properties, especially when a pneumatic object is perforated with a slender perforating object having walls comprising a thread.

However, they can in addition comprise various additives. Typically, these additives are present in a small amount (preferably at contents of less than 10 phr, more preferably of less than 5 phr) and are, for example, reinforcing fillers, such as carbon black, non-reinforcing or inert fillers, protective agents, such as UV stabilizers, antioxidants or antiozonants, various other stabilizers, or colouring agents which can preferably be used for the colouring of the self-sealing composition.

### 3.2 Preparation of the Self-Sealing Composition

The self-sealing compositions according to the invention can be obtained in the normal way, for example by incorporation of the different components in a twin-screw extruder or in a blade mixer, particularly having Z blades.

A first conventional way of obtaining the self-sealing compositions in accordance with the invention consists in incorporating, in a first stage, the thermoplastic styrene elastomer and the extender oil in a twin-screw extruder equipped with a sufficient number of conveying, shearing and retaining zones, so as to bring about the melting of the elastomer matrix and the incorporation of the extender oil. The twin-screw extruder can be any type of twin-screw extruder, the L/D ratio of which between the length and the diameter of the screw is within a range extending from 20 to 40, equipped with a hopper for feeding with the thermoplastic styrene elastomer and at least with a pressurized liquid injection pump for the extender oil. At the point of introduction of the thermoplastic styrene elastomer, the temperature is close to ambient temperature (23° C.). It is subsequently brought, further along the screw, to a value substantially greater than the melting point of the thermoplastic styrene elastomer selected and is within a range extending from 220 to 290° C. At the point of introduction of the extender oil, the temperature is also within a range extending from 220 to 290° C. At the outlet point of the extruder, the temperature is within a range extending from 110 to 170° C. The extruder is provided, at its outlet, with a die which makes it possible to shape the product to the desired dimensions. The overall outlet flow rate is within a range extending from 3 to 10 kg/h. With a cylindrical die, a rod is obtained, the diameter of which is within a range extending from 10 to 20 mm. With a flat die, a strip (profiled element) is obtained, the thickness of which is within a range extending from 1 to 3 mm and the width of which is within a range extending from 20 to 250.

In a second stage, the extrusion product obtained in the preceding stage and the polyolefin are introduced, using a hopper, into a single-screw or twin-screw extruder, the ratio L/D of which between the length and the diameter of the screw is within a range extending from 10 á 30. The temperature at the point of introduction, via the hoppers, of the extrusion product from the preceding stage and of the polyolefin is within a range extending from 100 to 180° C. at the screw inlet. At the screw outlet, the temperature is decreased and is then within a range extending from 100 to 150° C. With a cylindrical die, a self-sealing composition in accordance with the invention is obtained in the form of a rod having, for example, a diameter within a range extending from 10 to 20 mm. With a flat die, a self-sealing composition in accordance with the invention is obtained in the form of a strip (profiled element) having, for example, a thickness within a range extending from 1 to 3 mm and a width within a range extending from 20 to 250 mm.

When thermoplastic styrene elastomers, such as SEPSs or SEBSs, pre-extended with high content of oils are used, only the second extrusion stage may then be carried out in order to obtain the self-sealing compositions in accordance with the invention. Pre-extended thermoplastic styrene elastomers are well known and commercially available. Mention may be made, by way of example, of the products sold by Hexpol TPE under the name Dryflex (e.g., Dryflex 967100) or Mediprene (e.g., Mediprene 500 000M) or those sold by Multibase under the name Multiflex (e.g., Multiflex GOO).

Another conventional way of obtaining the self-sealing compositions in accordance with the invention consists of the use of a Z-blade mixer, for example of the MK LII 1 type from Linden, with a working capacity of one litre, to which the thermoplastic styrene elastomer, the extender oil and the polyolefin are charged. The vessel of the mixer is heated in order for the mixture to reach a temperature within a range extending from 80 to 140° C., according to the number of ingredients used. The speed of the blades is selected within a range extending from 10 to 100 revolutions/min and the duration of compounding is chosen within a range extending from 30 min to 24 hours. A person skilled in the art knows how to adjust each of these parameters in order to obtain a homogeneous mixture which will subsequently be used as self-sealing composition. In this case, a batch is obtained which does not exhibit a specific shape.

### 3.3 Use of the Self-Sealing Composition

Another subject-matter of the present invention relates to the use of a self-sealing composition and its preferred embodiments as defined above as puncture-resistant layer, in particular for a pneumatic object, especially for a pneumatic tyre.

The pneumatic object can be any object which takes its usable shape when inflated with an inflation gas (or gases), such as air, for example. Mention may be made, as examples of such pneumatic objects, of inflatable boats, pneumatic tyres or balls used for games or sports.

Such a puncture-resistant layer is preferably positioned on the internal wall of the pneumatic object, covering it completely or at least in part, but it can also be fully incorporated in its internal structure. The term “internal wall” is understood to mean the wall of the pneumatic object in contact with the inflation gas(es). This wall is formed of a layer which is airtight to inflation gases. Generally, this layer which is airtight to inflation gases comprises at least one butyl rubber.

The thickness of the puncture-resistant layer is preferably greater than or equal to 0.3 mm, more preferably is within a range extending from 0.5 mm to 10 mm (in particular from 1 to 7 mm). It will be easily understood that, according to the specific fields of application, the dimensions and the pressures involved, the embodiment of the invention can vary, the puncture-resistant layer then comprising several preferred ranges of thickness. Thus, for example, for pneumatic tyres of passenger vehicle type, it can have a thickness of at least 0.4 mm, preferably within a range extending from 0.8 to 6 mm. According to another example, for pneumatic tyres of heavy-duty or agricultural vehicles, the preferred thickness can be within a range extending from 1 to 7 mm. According to another example, for pneumatic tyres of vehicles in the field of civil engineering or for aircraft, the preferred thickness can be within a range extending from 2 to 10 mm. Finally, according to another example, for pneumatic tyres of bicycles, the preferred thickness can be within a range extending from 0.4 to 4 mm.

According to another specific embodiment of the invention, the self-sealing composition exhibits an elongation at break of greater than 500%, more preferably of greater than 800%, and a breaking stress of greater than 0.2 MPa, these two quantities being measured in first elongation (that is to say, without an accommodation cycle) at a temperature of 23° C., with a pull rate of 500 mm/min (Standard ASTM D412 of 2016), and with respect to the initial section of the test specimen.

3.4 Laminate which is Airtight to Inflation Gases and Puncture-Resistant and its Use

Another subject-matter of the present invention relates to a laminate which is airtight to inflation gases and puncture-resistant, in particular for a pneumatic object (such as a pneumatic tyre), comprising at least:
one puncture-resistant layer consisting of a self-sealing composition as defined above, including these preferred embodiments,
one layer airtight to inflation gases.

Preferably, the puncture-resistant layer of the laminate has a thickness of greater than or equal to 0.3 mm, more preferably within a range extending from 0.5 mm to 10 mm (in particular from 1 to 7 mm).

The layer airtight to inflation gases of the laminate can comprise any type of material which is capable of acting as film airtight to inflation gases, such as air, for example, whether it is, for example, a metallic material as thin as a polymer material.

According to a preferred embodiment, this layer airtight to inflation gases comprises a composition based on at least one butyl rubber. Preferably, this layer airtight to inflation gases comprises a composition based on at least one butyl rubber. The term “butyl rubber” should be understood as meaning, in a known way, a copolymer of isobutylene and of isoprene (abbreviated to IIR), and also the halogenated versions, preferably chlorinated or brominated versions, of this type of copolymer. Preferably, the butyl rubber is a halogenated butyl rubber or a blend of halogenated and non-halogenated butyls. The butyl rubber can be used alone or in combination with one or more other elastomer(s), especially diene elastomer(s), such as, for example, natural rubber or a synthetic polyisoprene. This composition moreover comprises the various additives usually present in layers airtight to inflation gases known to a person skilled in the art, such as reinforcing fillers, for example carbon black, lamellar fillers which improve airtightness (e.g., phyllosilicates, such as kaolin, talc, mica, clays or modified clays (organoclays)), protective agents, such as antioxidants or antiozonants, a crosslinking system (for example based on sulfur or on peroxide), various processing aids or other stabilizers.

The composition based on at least one butyl rubber is manufactured in appropriate mixers, using two successive phases of preparation well known to a person skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) down to a lower temperature, typically of less than 110° C., for example between 40° C. and 100° C., finishing phase during which the crosslinking system is incorporated. The final composition thus obtained is subsequently calendered, for example in the form of a sheet or of a plaque, or also extruded in the form of a rubber profiled element which can be used as layer airtight to inflation gases. Subsequently, it can be vulcanized.

Preferably, the layer airtight to inflation gases consisting of a composition based on butyl rubber and on a film of mould-release agents positioned at its surface. The composition of the film of mould-release agents and its positioning at the surface of the layer airtight to inflation gases are explained below.

Preferably, the layer airtight to inflation gases has a thickness of greater than or equal to 0.05 mm, more preferably within a range extending from 0.05 to 6 mm (for example from 0.1 to 2 mm).

The layer which is airtight to inflation gases and puncture-resistant of the invention can be prepared according to methods well known to a person skilled in the art, by separately preparing the two layers of the laminate and by then combining the puncture-resistant layer with the layer airtight to inflation gases, before or after the curing of the latter. The combining of the puncture-resistant layer with the layer airtight to inflation gases can be carried out, for example, by simple heat treatment, preferably under pressure (for example, a few min at 150° C. under 16 bars). In one embodiment, the combining of the puncture-resistant layer with the layer airtight to inflation gases can be carried out directly without addition of adhesive agents or else without inserting a third adhesive layer which would unify these two layers.

Another subject-matter of the present invention relates to the use of a laminate which is airtight to inflation gases and puncture-resistant and its preferred embodiments as internal wall of a pneumatic object, in particular of a pneumatic tyre.

### 3.5 Pneumatic Object

Another subject-matter of the present invention relates to a pneumatic object comprising a self-sealing composition as defined above, including its preferred embodiments.

Preferably, the pneumatic object comprises an internal wall on which the said self-sealing composition is deposited. Preferably, the pneumatic object is a pneumatic tyre (in particular for a vehicle).

Another subject-matter of the present invention relates to a pneumatic object comprising a laminate which is airtight to inflation gases and puncture-resistant as defined above, including its preferred embodiments. Preferably, the pneumatic object comprises a laminate which is airtight to inflation gases and puncture-resistant which constitutes the internal wall of the said pneumatic object. Preferably, the pneumatic object is a pneumatic tyre.

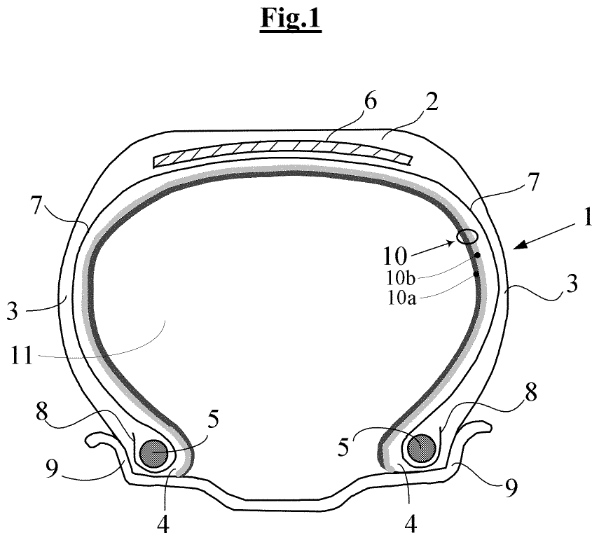

FIG. 1 diagrammatically represents (without observing a specific scale) a radial section of a pneumatic tyre incorporating a laminate in accordance with the invention.

This pneumatic tyre 1 comprises a crown 2 reinforced by a crown reinforcement or belt 6, two sidewalls 3 and two beads 4, each of these beads 4 being reinforced with a bead wire 5. The crown 2 is surmounted by a tread, not represented in this diagrammatic figure. A carcass reinforcement 7 is wound around the two bead wires 5 in each bead 4, the turn-up 8 of this reinforcement 7 being, for example, positioned towards the outside of the tyre 1, which is represented here fitted onto its wheel rim 9. The carcass reinforcement 7 is, in a way known per se, formed of at least one ply reinforced by “radial” cords, for example made of textile or metal, that is to say that these cords are positioned virtually parallel to one another and extend from one bead to the other so as to form an angle of between 80° and 90° with the median circumferential plane (plane perpendicular to the axis of rotation of the tyre which is located midway between the two beads 4 and passes through the middle of the crown reinforcement 6).

The pneumatic tyre 1 is characterized in that its internal wall comprises a multilayer laminate in accordance with the invention as defined above, comprising at least two layers 10a, 10b, a puncture-resistant layer 10a consisting of a self-sealing composition in accordance with the invention and a layer 10b airtight to inflation gases.

In accordance with a preferred embodiment of the invention, the two layers 10a, 10b cover substantially the entire inner wall of the pneumatic tyre, extending from one sidewall to the other, at least as far as the level of the rim flange when the pneumatic tyre is in the fitted position. According to other possible embodiments, the puncture-resistant layer 10a might, however, cover only a part of the region airtight to inflation gases (layer 10b), for example only the crown region of the pneumatic tyre, or might extend at least from the crown region as far as the middle of the sidewall (equator) of the said tyre.

According to another preferred embodiment, the laminate is positioned in such a way that the puncture-resistant layer 10a is radially the outermost in the pneumatic tyre, with respect to the other layer 10b, as represented diagrammatically in FIG. 1. In other words, the puncture-resistant layer 10a covers the layer 10b airtight to inflation gases on the side of the internal cavity 11 of the pneumatic tyre 1. Another possible embodiment is that where this layer 10a is radially the innermost, then positioned between the airtight layer 10b and the remainder of the structure of the tyre 1.

The layer 10b airtight to inflation gases thus makes it possible to inflate the tyre 1 and to keep it pressurized; its airtightness properties allow it to guarantee a relatively low rate of loss of pressure, making it possible to keep the tyre inflated, in a normal operating state, for a sufficient period of time, normally several weeks or several months.

This puncture-resistant layer 10a, which consists of a self-sealing composition in accordance with the invention (including its preferred embodiments), is thus positioned between the layer 10b and the cavity 11 of the tyre. It makes it possible to provide the pneumatic tyre with effective protection against pressure losses due to accidental perforations, by making possible the automatic sealing of these perforations.

If a perforating object, such as a nail or a screw, passes through the structure of the pneumatic object, for example a wall, such as a sidewall 3, or the crown 6 of the pneumatic tyre 1, the self-sealing composition in accordance with the invention acting as puncture-resistant layer is subjected to several stresses. On reacting to these stresses, and by virtue of its advantageous properties of deformability and elasticity, the said self-sealing composition in accordance with the invention creates an airtight contact region all around the perforating object. The flexibility of the self-sealing composition in accordance with the invention allows the latter to intrude into openings of minimum size, whatever the shape of the perforating object. This interaction between the self-sealing composition in accordance with the invention and the perforating object confers an airtightness on the region affected by the latter.

In the event of removal, accidental or deliberate, of the perforating object, a perforation remains: the latter is capable of creating a leak of greater or lesser significance according to its size. The self-sealing composition in accordance with the invention, subjected to the effect of hydrostatic pressure, is sufficiently flexible and deformable to seal off the perforation by being deformed, preventing inflating gas from leaking out. In the case in particular of a pneumatic tyre, it has turned out that the flexibility of the self-sealing composition in accordance with the invention makes it possible to withstand, without any problem, the strains of the surrounding walls, even during phases in which the loaded pneumatic tyre deforms when running.

Preferably, the pneumatic object is a pneumatic tyre, in particular intended to equip vehicles. These vehicles can be motor vehicles of passenger vehicle type, SUV (“Sports Utility Vehicles”) vehicles, two-wheel vehicles (in particular motorcycles) or aircraft, and industrial vehicles chosen from vans, heavy-duty vehicles—that is to say, underground trains, buses, heavy road transport vehicles (lorries, tractors, trailers) or off-road vehicles, such as agricultural vehicles or earthmoving equipment—or other transportation or handling vehicles.

Preferably, the pneumatic object comprises an internal wall on which at least one self-sealing composition as defined above, including its preferred embodiments, is deposited.

Preferably, the internal wall of the pneumatic object comprises, at its surface, a film of mould-release agents on which the said self-sealing composition in accordance with the present invention is deposited. Films of mould-release agents are well known to a person skilled in the art. The term “film” is understood to mean a thin layer of a material (or composition) deposited at the surface of a support.

The film of mould-release agents and its use are well known to manufacturers of pneumatic objects. Usually, this film is applied to the surface of the non-crosslinked layer airtight to inflation gases according to any technique well known to a person skilled in the art. This is because the layer airtight to inflation gases (or internal wall of a pneumatic tyre) exhibits a strong adhesiveness in the raw state. In order to prevent the raw pneumatic tyre from sticking to the curing bladder of the vulcanization press and from damaging this press, it is normal to deposit a film of mould-release agents on this internal wall. This film of agents acts as a non-stick protective layer.

Preferably, the film of mould-release agents comprises at least one silicone polymer or a mixture of silicon polymers and talc. Preferably, the film of mould-release agents consists of a silicone polymer or of a mixture of silicon polymers and of talc.

The film of mould-release agents can, for example, be obtained by spraying an aqueous suspension of one or more silicone polymers and of talc over the surface of the non-crosslinked layer airtight to inflation gases.

Preferably, the film of mould-release agents has a thickness strictly of less than 0.5 mm.

Preferably, the film of mould-release agents has a thickness within a range extending from 0.02 to 0.3 mm.

The thickness of the film of mould-release agents is measured according to the method described above.

When this mould-release agent film is present at the surface of the layer airtight to inflation gases, the layers of the laminate in accordance with the invention are superimposed in the following way: the layer airtight to inflation gases (optionally crosslinked), a mould-release agent film and the self-sealing layer.

The pneumatic object can be manufactured by any technique well known to a person skilled in the art.

For example, when the pneumatic object is a pneumatic tyre, the self-sealing composition as defined above, including its preferred alternative forms, is applied before or after the curing of the pneumatic tyre.

Before curing, this consists in positioning the self-sealing composition as defined above, including its preferred alternative forms, on the layer airtight to inflation gases (or internal wall), that is to say in applying the self-sealing composition in accordance with the invention in the form of a layer with a thickness of greater than or equal to 0.3 mm to the internal rubber, and in then carrying out the curing of the pneumatic tyre. It may be necessary to protect the puncture-resistant layer with a non-stick layer or a protective film. The non-stick layer or the protective film facilitates the manufacture the pneumatic tyre by limiting the direct contacts between the puncture-resistant layer and the tools for assembling the preform of the tyre or between the puncture-resistant layer and the bladder of the curing presses. These non-stick layers or protective films and their use are well known to a person skilled in the art.

After curing, this consists in positioning the self-sealing composition as defined above, including its preferred alternative forms, on the precured (vulcanized) layer airtight to inflation gases (or internal wall). The self-sealing composition in accordance with the invention forming the puncture-resistant layer is applied by any appropriate means, such as, for example, by adhesive bonding, by spraying or also extrusion and blowing of a layer with a thickness of greater than or equal to 0.3 mm.

According to one embodiment, this positioning of the self-sealing composition can be carried out on a cured layer airtight to inflation gases, the film of mould-release agents of which will have been removed beforehand, in particular by scraping or by dissolution with solvents.

According to another embodiment, the positioning of the self-sealing composition in accordance with the invention, including of its preferred versions, can also be carried out directly on the film of mould-release agents which occurs at the surface of the layer airtight to inflation gases which has been cured. This embodiment is advantageous since it no longer requires the use of a scraper or of solvent in order to remove the film of mould-release agents. This results in a saving in time and in a gain in safety for the manufacturer.

In addition to the subject-matters described above, the invention relates to at least one of the subject-matters explained in detail in the following points:

1. A self-sealing composition based on at least:
one thermoplastic styrene elastomer;
one polyolefin having a number-average molar mass Mn ranging from more than 550 000 to 5 000 000 g/mol; and
at least 140 phr of an extender oil.
   2. A self-sealing composition according to point 1, in which the thermoplastic styrene elastomer is selected from the group consisting of saturated thermoplastic styrene elastomers and the mixtures of these elastomers.
   3. A self-sealing composition according to point 2, in which the saturated thermoplastic styrene elastomer is selected from the group consisting of styrene/ethylene/butylene (SEB), styrene/ethylene/propylene (SEP), styrene/ethylene/ethylene/propylene (SEEP), styrene/ethylene/butylene/styrene (SEB S), styrene/ethylene/propylene/styrene (SEPS), styrene/ethylene/ethylene/propylene/styrene (SEEPS) copolymers and the mixtures of these copolymers.
   4. A self-sealing composition according to point 2, in which the thermoplastic styrene elastomer is selected from the group consisting of saturated triblock thermoplastic styrene elastomers and the mixtures of these elastomers.
   5. A self-sealing composition according to point 4, in which the saturated triblock thermoplastic styrene elastomer is selected from the group consisting of styrene/ethylene/butylene/styrene (SEBS) copolymers, styrene/ethylene/propylene/styrene (SEPS) copolymers and the mixtures of these copolymers.
   6. A self-sealing composition according to any one of points 1 to 5, in which the number-average molar mass Mn of the thermoplastic styrene elastomer is less than or equal to 500 000 g/mol.
   7. A self-sealing composition according to any one of points 1 to 6, in which the number-average molar mass Mn of the thermoplastic styrene elastomer is within a range extending from 30 000 to 500 000 g/mol, preferably from 40 000 to 400 000 g/mol, more preferably still from 50 000 to 300 000 g/mol.
   8. A self-sealing composition according to any one of points 1 to 7, in which the content of thermoplastic styrene elastomer is greater than or equal to 10 phr, preferably within a range extending from 10 to 90 phr, more preferably within a range extending from 20 to 80 phr, more preferably still within a range extending from 25 to 75 phr.
   9. A self-sealing composition according to any one of points 1 to 8, in which the polyolefin comprises units resulting from olefinic monomers having from 4 to 8 carbon atoms.
   10. A self-sealing composition according to point 9, in which the olefinic monomers having from 4 to 8 carbon atoms are selected from the group consisting of but-1-ene, but-2-ene, 2-methylpropene, pent-1-ene, pent-2-ene, 2-methyl-1-butene, 2-methyl-2-butene, 3-methyl-1-butene, hex-1-ene, 4-methyl-1-pentene, 3-methyl-1-pentene, hept-1-ene and oct-1-ene, and the mixtures of these olefinic monomers.
   11. A self-sealing composition according to either one of points 9 and 10, in which the polyolefin comprises units resulting from olefinic monomers having 4 carbon atoms selected from the group consisting of but-1-ene, but-2-ene, 2-methylpropene and the mixtures of these olefinic monomers.
   12. A self-sealing composition according to point 11, in which the polyolefin consists of units resulting from 2-methylpropene monomers.
   13. A self-sealing composition according to any one of points 1 to 12, in which the polyolefin has a number-average molar mass Mn ranging from 600 000 to 5 000 000 g/mol, preferably ranging from 700 000 to 4 000 000 g/mol, more preferably ranging from 800 000 to 3 000 000 g/mol.
   14. A self-sealing composition according to any one of points 1 to 13, in which the polyolefin has a polydispersity index PI ranging from 1.1 to 6, preferably ranging from 1.3 to 5.
   15. A self-sealing composition according to any one of points 1 to 14, in which the content of polyolefin is greater than or equal to 10 phr, preferably is within a range extending from 10 to 90 phr, more preferably is within a range extending from 20 to 80 phr, more preferably still is within a range extending from 25 to 75 phr.
   16. A self-sealing composition according to any one of points 1 to 15, in which the extender oil is selected from the group consisting of polyolefinic oils, paraffinic oils, naphthenic oils, aromatic oils, mineral oils and the mixtures of these oils.
   17. A self-sealing composition according to point 16, in which the extender oil is selected from the group consisting of polyolefinic oils, paraffinic oils and the mixtures of these oils.
   18. A self-sealing composition according to point 17, in which the extender oil is a polyolefinic oil selected from the group consisting of polybutene oils and the mixtures of these oils. And the mixtures
   19. A self-sealing composition according to point 18, in which the extender oil is selected form the group consisting of polyisobutylene oils and the mixtures of these oils.
   20. A self-sealing composition according to any one of points 1 to 19, in which the number-average molar mass Mn of the extender oil is less than 5000 g/mol, preferably within a range extending from 300 to 5000 g/mol, preferably from 350 to 3000 g/mol.
   21. A self-sealing composition according to any one of points 1 to 20, in which the content of extender oil is within a range extending from 145 to 500 phr, preferably from 145 to 400 phr, more preferably from 145 to 350 phr.
   22. A use of a self-sealing composition according to any one of points 1 to 21, as puncture-resistant layer, in particular for a pneumatic object.
   23. A use according to point 22, in which the puncture-resistant layer has a thickness of greater than or equal to 0.3 mm, preferably within a range extending from 0.5 to 10 mm, more preferably from 1 to 7 mm.
   24. A laminate which is airtight to inflation gases and puncture-resistant, in particular for a pneumatic object, comprising at least:
one puncture-resistant layer consisting of a self-sealing composition as defined in any one of points 1 to 21,
one layer airtight to inflation gases.
   25. A laminate according to point 24, in which the puncture-resistant layer has a thickness of greater than or equal to 0.3 mm, preferably within a range extending from 0.5 mm to 10 mm, more preferably from 1 to 7 mm.
   26. A laminate according to point 24 or 25, in which the layer airtight to inflation gases comprises a butyl rubber.
   27. A laminate according to any one of points 24 to 26, in which the thickness of the layer airtight to inflation gases is greater than or equal to 0.05 mm, preferably within a range extending from 0.05 to 6 mm, more preferably from 0.1 to 2 mm.
   28. A use of a laminate according to any one of points 24 to 27 as internal wall of a pneumatic object, in particular of a pneumatic tyre.
   29. A pneumatic object comprising at least one self-sealing composition as defined in any one of points 1 to 21.
   30. A pneumatic object according to point 29, comprising an internal wall on which the said self-sealing composition is deposited.
   31. A pneumatic object according to point 30, in which the internal wall comprises, at its surface, a film of mould-release agents on which the said self-sealing composition is deposited.
   32. A pneumatic object comprising at least one laminate which is airtight to inflation gases and puncture-resistant as defined according to any one of points 24 to 27.
   33. A pneumatic object according to any one of points 29 to 32, characterized in that it is a pneumatic tyre.

### Examples

The examples which follow illustrate the invention without, however, limiting it.

### 4.1 Manufacture of the Self-Sealing Compositions:

The self-sealing compositions in accordance with the invention are prepared in a conventional way by extrusion, in two stages, of the thermoplastic styrene elastomer A, of the extender oil and of the polyolefin.

In the first stage, the thermoplastic styrene elastomer A and the extender oil are introduced into the twin-screw L/D=40 extruder via a feed hopper for the elastomer and a pressurized liquid injection pump for the extender oil. The twin-screw extruder is provided with a flat die which makes it possible to extrude the product at the desired dimensions. The temperature at the point of introduction of the thermoplastic elastomer is at ambient temperature (23° C.). It is subsequently brought, further along the screw, to a value substantially greater than the melting point of the thermoplastic styrene elastomer selected, that is to say to 275° C. At the point of introduction of the oil, the temperature is also 275° C. At the outlet point of the extruder, the temperature is 140° C. The overall flow rate is, at the outlet, 4 kg/h.

During the second stage, the profiled element obtained by extrusion from the first stage and the polyolefin are introduced into a twin-screw L/D=20 extruder via hoppers. The temperature at the point of introduction via the hoppers of the polyolefin and of the preceding profiled element comprising the thermoplastic elastomer and the extender oil is 125° C. at the screw inlet. At the screw outlet, the temperature is lowered to 125° C.

When the self-sealing compositions are used as puncture-resistant layer, the extruder of the second stage comprises, in place of the die, an application nozzle known to a person skilled in the art (see, for example, section [0048] of Application WO2015/173120A1).

The self-sealing compositions of the prior art as described in the document WO2008/080557A1 are prepared in the same way as the self-sealing compositions in accordance with the invention, with the exception of the second stage, which is not carried out. When these self-sealing compositions are used as puncture-resistant layer, the extruder of the first stage then comprises an application nozzle as described above as replacement for its die.

4.2 Preparation of the Pneumatic Tyre with a Puncture-Resistant Layer

The self-sealing compositions obtained above are subsequently used as puncture-resistant layer in a 225/55 R18 Michelin Primacy 3 pneumatic tyre.

They are installed directly on the airtight layer of the pneumatic tyre using the device and the process described in Application WO2015/173120A1 (which also applies to the non-crosslinked self-sealing compositions).

More specifically, a self-sealing layer with a thickness of approximately 4 mm is obtained by successive and circular depositions of profiled elements with a thickness of approximately 0.8 mm and with a width of approximately 10 mm obtained at the outlet of the application nozzle. The self-sealing composition is applied directly to the airtight layer devoid of a film of mould-release agents.

### 4.3 Test of the Resistance of a Pneumatic Tyre to a Puncture

The self-sealing properties of the self-sealing compositions in a pneumatic tyre can be evaluated by a test of resistance to loss in pressure resulting from a puncture. This test is carried out according to the following process.

Pneumatic tyres obtained in section 4.2 provided with the self-sealing composition to be tested are each fitted onto an appropriate wheel and are inflated to 2.5 bar. The pressure is regulated at 2.5 bar.

The test is carried out with the following perforating objects:
12 screws having a diameter of 3.5 mm and a length of 30 mm and 12 screws having a diameter of 3.5 mm and a length of 40 mm. The 24 screws are placed on the same pneumatic tyre. The screws are new and rust-free (“screw” test).
12 nails having a diameter of 3 mm and a length of 30 mm and 12 nails having a diameter of 3 mm and a length of 40 mm. The 24 nails are placed on the same pneumatic tyre. The nails are new and rust-free (“nail” test).

One pneumatic tyre is used for the “screw” test and another for the “nail” test.

Each perforating object is inserted vertically with respect to the tread by virtue of a hydraulic jack until it has completely penetrated, the head of the perforating object being in abutment in the bottoms of the longitudinal or lateral grooves of the pattern of the tread. The perforating objects are inserted on a pneumatic tyre, fitted and inflated and pressure-regulated at 2.5 bar, which has not yet run, the temperature of the crown of the tyre being equal to 50° C.

For each insertion, the leakages are evaluated using a surface-active agent as indicated below. The mean of the grades obtained is taken and an “insertion” grade is obtained.

The inflated pneumatic tyre/wheel assembly is subsequently attached to the hub of a roller with a developed length of five to six metres.

The running conditions are as follows: the inflation pressure is regulated at 2.5 bar, the load applied is of the order of 70% of the load rating of the tyre, the temperature in the chamber of the roller is regulated at approximately 20° C. and the rolling is a straight rolling, without torque or drift or camber applied. The speed is regulated at 70 km/h for 4 hours. A single rolling phase is carried out.

On conclusion of this running phase and on return of the fitted assembly to ambient temperature (ambient temperature is approximately 23° C.), the leakages are evaluated using a surface-active agent as indicated below. The mean of the grades obtained is taken and a “running” grade is obtained.

Each perforating object in place is then extracted and the leakages are instantaneously evaluated using a surface-active agent as indicated below. The mean of the grades obtained is taken and a “withdrawal” grade is obtained.

The result of the test is a qualitative observation of the leakages of each perforation before running (or insertion), after running (running) and after extraction (or withdrawal).

The leakages are evaluated using a surface-active agent, for example an aerosol spray of the “1000 bulles [1000 bubbles]” trademark sold by Air Liquide. The product is sprayed over the perforation and the observer records the presence, the size and the number of the bubbles using a magnifying glass and under strong lighting.

The following grading scheme is used to assess the leakage rate of a perforation:
10: no bubble is visible; there is no leakage;
8: nanoleakage, very small bubbles with a diameter of less than 0.1 mm are visible, in particular with a magnifying glass.
6: microleakage, small bubbles visible to the naked eye with a diameter of between 0.1 and 1 mm;
0: leakage, developing bubbles with a diameter of greater than 1 mm or no bubbles due to an excessively great loss in pressure.

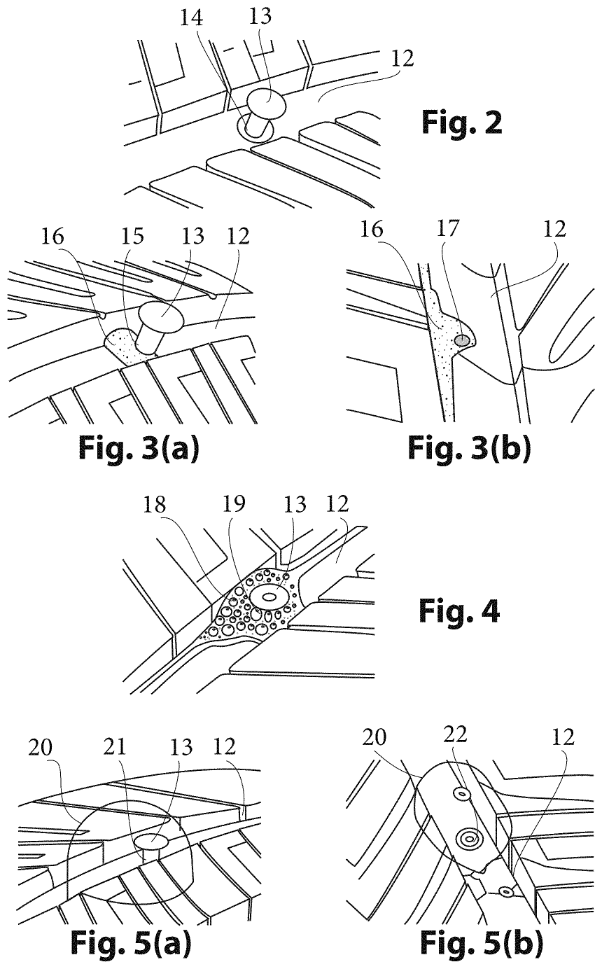

FIGS. 2 to 5 illustrate the different cases observed with the perforating objects in place (FIGS. 2, 3(a), 4 and 5(a)) and after their extraction or ejection (FIG. 3(b), 5(b)). The perforating object in the figures is a nail.

In FIG. 2, a nail 13 passing through a perforation 14 positioned in the longitudinal groove 12 of the pneumatic tyre is seen. No bubble is seen, there is no leakage and the perforation is graded 10.

In FIG. 3(a), a nail 13 passing through a perforation 15 positioned in the longitudinal groove 12 of the pneumatic tyre is seen. The application of the surface-active product makes it possible to display a large number of very small bubbles 16, visible only with a magnifying glass and with a diameter of less than 0.1 mm. It is a nanoleakage, graded 8.

In FIG. 3(b), a perforation 17 made by a nail which has been extracted after stopping the running is seen. The perforation 17 is also located in the exterior longitudinal groove 12 of the pneumatic tyre. The application of the surface-active product also makes it possible to display a large number of very small bubbles 16, visible with a magnifying glass and with a diameter of less than 0.1 mm. The same grading 8 is given.

In FIG. 4, a nail 13 passing through a perforation 19 positioned in the exterior longitudinal groove 12 of the pneumatic tyre is seen. The application of the surface-active product makes it possible to display a collection of small bubbles 18 with a diameter substantially of between 0.1 mm and 1 mm. It is a microleakage, graded 6.

In FIG. 5(a), a nail 13 passing through a perforation 21 positioned in an exterior longitudinal groove 12 of the pneumatic tyre is seen. The application of the surface-active product makes it possible to display a single large bubble 20 with a diameter of greater than 1 mm. A leakage, graded 0, is present.

In FIG. 5(b), a perforation 22 made by a nail which has been extracted after stopping the running is seen in the exterior longitudinal groove 12 of the pneumatic tyre. In the same way, only a single large bubble 20 with a diameter of greater than 1 mm is seen. It is a leakage, graded 0.

### 4.4 Test

The aim of this test is to demonstrate that the self-sealing composition in accordance with the invention (composition I1) has improved self-sealing properties, in comparison with compositions not comprising polyolefin of high molecular weight (compositions C1 and C2) in accordance with the teaching of WO2008/080557.

The formulations of the compositions tested are presented in Table I; the contents are expressed in phr (parts by weight per 100 parts by weight of elastomer).

TABLE I

| Compositions (phr) | C1 | C2 | I1 |
|---|---|---|---|
| TPS (a) | 100 | 100 | 44 |
| Polyolefin (b) | 0 | 0 | 56 |
| Extender oil (c) | 570 | 400 | 178 |
| Ratio of the TPS in phr to the | 0.17 | 0.25 | 0.25 |
| extender oil in phr | | | |

(a) Thermoplastic styrene elastomer (TPS): styrene/ethylene/butylene/styrene SEBS block copolymer sold by Kraton under the reference G1654; Mn=116 000 g/mol, PI=1.1; Mn and PI measured according to the method described in the description.
(b) Polyolefin: polyisobutylene sold by BASF under the reference Oppanol 100. Mn=1 000 000 g/mol, PI=3.1; Mn and PI measured according to the method described in the description.
(c) Extender oil: polyisobutylene oil sold by Univar under the reference Dynapak 190. Mn=1000 g/mol, PI=1.4; Mn and PI measured according to the method described in the description.

The composition I1 in accordance with the invention differs from the compositions C1 and C2 in that it additionally comprises a polyolefin of high molar mass.

Each self-sealing composition is obtained according to the process described in section 4.1 and then applied as puncture-resistant layer on a pneumatic tyre in accordance with the process described in section 4.2. The pneumatic tyres are subsequently subjected to a test of resistance to puncturing in accordance with the process described in section 4.3.

The puncture resistance results of the pneumatic tyres comprising the self-sealing compositions used as puncture-resistant layer are presented in Table II (nail test) and in Table III (screw test).

TABLE II

| | | Pneumatic tyre | | |
|---|---|---|---|---|
| | | CT1 | CT2 | T1 |
| | | Self-sealing composition used | | |
| | | C1 | C2 | I1 |
| Nail with a | Insertion grade (mean) | 10 | 10 | 10 |
| length of 30 | Running grade (mean) | 10 | 10 | 10 |
| mm | Withdrawal grade (mean) | 10 | 10 | 10 |
| Nail with a | Insertion grade (mean) | 10 | 10 | 10 |
| length of 40 | Running grade (mean) | 10 | 10 | 10 |
| mm | Withdrawal grade (mean) | 8 | 8 | 10 |

From Table 2, it is noted that the self-sealing composition in accordance with the invention I1 and also the control compositions C1 and C2 exhibit very good self-sealing properties when the perforations are produced with nails. This is because no leakage is observed on the pneumatic tyres T1, CT1 and CT2 during the insertion and running phases. A nanoleakage is observed on the pneumatic tyres CT1 and CT2 during the withdrawal phase of the nail. However, this leakage is not incompatible with the use of these pneumatic tyres.

TABLE III

| | | Pneumatic tyre | | |
|---|---|---|---|---|
| | | CT1 | CT2 | T2 |
| | | Self-sealing composition used | | |
| | | C1 | C2 | I1 |
| Screw with | Insertion grade (mean) | 6 | 6 | 6 |
| a length of | Running grade (mean) | 6 | 6 | 10 |
| 30 mm | Withdrawal grade (mean) | 8 | 8 | 8 |
| Screw with | Insertion grade (mean) | 0 | 0 | 6 |
| a length of | Running grade (mean) | 6 | 6 | 8 |
| 40 mm | Withdrawal grade (mean) | 6 | 6 | 10 |

From Table III, the appearance of nano- and microleakages in the pneumatic tyres CT1 and CT2 is recorded during the insertion and rolling phase in the test carried out with screws with a length of 30 mm. The perforation of these same pneumatic tyres with screws with a length of 40 mm results in leakages during the insertion and rolling phases, rendering this pneumatic tyre unusable after perforation by a screw.

Compared with the test with the nails (Table II), it is observed that the self-sealing properties of the compositions C1 and C2 are greatly reduced when screws are used as perforating object as replacement for the nails.

Surprisingly, the self-sealing composition in accordance with the invention (composition I1), in comparison with the composition of the prior art C1, does not exhibit this fall in performance quality. This is because no leakage is observed during the rolling phase with the 30 mm screws, and no leakage is observed with the 40 mm screws apart from the insertion phase, where a small leakage is observed.

To sum up, the self-sealing composition in accordance with the invention thus exhibits improved self-sealing properties, in comparison with the representative compositions of the prior art WO2008/080557-A1.

1.-15. (canceled)

16. A self-sealing composition based on at least:
a thermoplastic styrene elastomer;
a polyolefin having a number-average molar mass Mn ranging from more than 550 000 to 5 000 000 g/mol; and
at least 140 phr of an extender oil.

17. The self-sealing composition according to claim 16, wherein the thermoplastic styrene elastomer is selected from the group consisting of saturated thermoplastic styrene elastomers and mixtures thereof.

18. The self-sealing composition according to claim 17, wherein a saturated thermoplastic styrene elastomer is selected from the group consisting of styrene/ethylene/butylene (SEB), styrene/ethylene/propylene (SEP), styrene/ethylene/ethylene/propylene (SEEP), styrene/ethylene/butylene/styrene (SEBS), styrene/ethylene/propylene/styrene (SEPS), styrene/ethylene/ethylene/propylene/styrene (SEEPS) copolymers and mixtures thereof.

19. The self-sealing composition according to claim 16, wherein the number-average molar mass Mn of the thermoplastic styrene elastomer is less than or equal to 500 000 g/mol.

20. The self-sealing composition according to claim 16, wherein a content of thermoplastic styrene elastomer is greater than or equal to 10 phr.

21. The self-sealing composition according to claim 20, wherein the content of thermoplastic styrene elastomer is within a range extending from 10 to 90 phr.

22. The self-sealing composition according to claim 16, wherein the polyolefin comprises units resulting from olefinic monomers having from 4 to 8 carbon atoms.

23. The self-sealing composition according to claim 22, wherein the olefinic monomers having from 4 to 8 carbon atoms are selected from the group consisting of but-1-ene, but-2-ene, 2-methylpropene, pent-1-ene, pent-2-ene, 2-methyl-1-butene, 2-methyl-2-butene, 3-methyl-1-butene, hex-1-ene, 4-methyl-1-pentene, 3-methyl-1-pentene, hept-1-ene and oct-1-ene, and mixtures thereof.

24. The self-sealing composition according to claim 22, wherein the polyolefin comprises units resulting from olefinic monomers having 4 carbon atoms selected from the group consisting of but-1-ene, but-2-ene, 2-methylpropene and mixtures thereof.

25. The self-sealing composition according to claim 16, wherein the polyolefin has a number-average molar mass Mn ranging from 600 000 g/mol to 500 000 g/mol.

26. The self-sealing composition according to claim 25, wherein the polyolefin has a number-average molar mass Mn ranging from 40 000 to 400 000 g/mol.

27. The self-sealing composition according to claim 16, wherein a content of polyolefin is greater than or equal to 10 phr.

28. The self-sealing composition according to claim 27, wherein the content of polyolefin is within a range extending from 10 to 90 phr.

29. The self-sealing composition according to claim 16, wherein the extender oil is selected from the group consisting of polyolefinic oils, paraffinic oils, naphthenic oils, aromatic oils, mineral oils and mixtures thereof.

30. The self-sealing composition according to claim 29, wherein the extender oil is selected from the group consisting of polyolefinic oils, paraffinic oils and mixtures thereof.

31. The self-sealing composition according to claim 16, wherein the content of extender oil is within a range extending from 145 to 500 phr.

32. The self-sealing composition according to claim 31, wherein the content of extender oil is within a range extending from 145 to 400 phr.

33. A laminate which is airtight to inflation gases and puncture resistant comprising at least:
a puncture-resistant layer consisting of a self-sealing composition according to claim 16; and
a layer airtight to inflation gases.

34. A pneumatic object comprising at least one self-sealing composition according to claim 16.
